(19) United States
(12) Patent Application Publication
(10) Pub. No.: US 2022/0365824 A1
(43) Pub. Date: Nov. 17, 2022

(54) SCALING OF DISTRIBUTED SOFTWARE APPLICATIONS USING SELF-PERCEIVED LOAD INDICATORS

(71) Applicant: Hewlett-Packard Development Company, L.P., Spring, TX (US)

(72) Inventors: Mauricio Coutinho Moraes, Porto Alegre (BR); Jhonny Marcos Acordi Mertz, Porto Alegre (BR); Leonardo Dias Marquezini, Porto Alegre (BR)

(73) Assignee: Hewlett-Packard Development Company, L.P., Spring, TX (US)

(21) Appl. No.: 17/767,109

(22) PCT Filed: Oct. 30, 2019
(86) PCT No.: PCT/US2019/058694

§ 371 Date: Apr. 7, 2022

(51) Int. Cl. G06F 9/50

(52) U.S. Cl. CPC G06F 9/5027

(57) ABSTRACT

A system includes: a distributed computing subsystem to execute an adjustable number of instances of a request handling process; and a scaling control subsystem connected with the distributed computing subsystem to: allocate received requests among the instances of the request handling process; receive respective self-perceived load indicators from each of the instances of the request handling process; generate, based on the self-perceived load indicators, a total load indicator of the distributed computing subsystem; and compare the total load indicator to a threshold to select an adjustment action; and instruct the distributed computing subsystem to adjust the number of instances of the request handling process, according to the selected adjustment action.

### BACKGROUND

A software application executable to respond to requests from client computing devices may be deployed as multiple application instances. The number of application instances may be altered over time to accommodate variations in the volume of requests received from the client computing devices.

### BRIEF DESCRIPTIONS OF THE DRAWINGS

FIG. 1 is a diagram of a computing system to scale distributed software applications using self-perceived load indicators.

FIG. 2 is a diagram illustrating certain internal components of the scaling control subsystem and the distributed computing subsystem of FIG. 1.

FIG. 3 is a flowchart of a method of scaling distributed software applications using self-perceived load indicators.

FIG. 4 is a diagram illustrating a performance of blocks 405 and 410 of the method of FIG. 3.

FIG. 5 is a flowchart of a method for performing block 320 of the method of FIG. 3.

FIG. 6 is a diagram illustrating a performance of block 325 of the method of FIG. 3.

FIG. 7 is a flowchart of a method for performing block 345 of the method of FIG. 3.

FIG. 8 is a diagram illustrating the distributed computing subsystem of FIG. 2 following a performance of block 350 of the method of FIG. 3.

### DETAILED DESCRIPTION

Software applications may be implemented in distributed computing systems, in which a plurality of sets of execution hardware (e.g. processors, memories and the like) are available to execute an adjustable number of instances of a given software application. The number of instances of the software application may be controllable in response to variations in computational load to be accommodated.

For example, a distributed software application may receive and respond to requests from client computing devices. The distributed software application may therefore also be referred to as a request handling process. The requests may be requests for web pages, login or other authentication requests, or the like. An increase in a rate of incoming requests may be accommodated by spawning additional instances of the request handling process. Conversely, a decrease in the rate of incoming requests may permit a reduction in the number of instances, which may release some of the above-mentioned execution hardware for other tasks.

Adjusting the number of instances of a request handling process executed at a distributed computing system may include collecting information such as central processing unit (CPU) usage levels, a rate at which requests are received, and the like. Based on the collected information, an estimate of computational resources to accommodate the incoming requests may be generated, such as an estimated number of instances. The estimate may be compared to the existing number of instances, and the number of instances may be modified to match the estimate.

However, some of the information mentioned above may be difficult to correlate accurately with computational load on the distributed software application. For example, CPU usage can be impacted by various factors that are not related to the distributed software application. Load estimation mechanisms can therefore be computationally costly and/or error-prone. As a result, adjustments to the number of instances of a distributed software application may not be made in a timely manner, or may not be made at all, leading to reduced performance or unnecessary allocation of execution hardware.

To provide automatic scaling of a distributed software application that is more responsive while mitigating the computational cost of automatic scaling, a scaling control subsystem receives self-perceived load indicators from instances of the distributed software application themselves. The scaling control subsystem then processes the self-perceived load indicators to select an adjustment action.

In the examples, a system includes: a distributed computing subsystem to execute an adjustable number of instances of a request handling process; and a scaling control subsystem connected with the distributed computing subsystem to: allocate received requests among the instances of the request handling process; receive respective self-perceived load indicators from each of the instances of the request handling process; generate, based on the self-perceived load indicators, a total load indicator of the distributed computing subsystem; compare the total load indicator to a threshold to select an adjustment action; and instruct the distributed computing subsystem to adjust the number of instances of the request handling process, according to the selected adjustment action.

The distributed computing subsystem can execute each instance of the request handling process to: generate responses to a subset of the requests allocated to the instance; for each response, generate at least one execution timestamp; and generate the self-perceived load indicator based on the at least one execution timestamp.

Execution of each instance of the request handling process can cause the distributed computing subsystem to: determine an execution time based on the at least one execution timestamp; determine a ratio of the execution time to a stored benchmark time; and return the ratio as the self-perceived load indicator.

The scaling control subsystem, in order to generate the total load indicator, can generate an average of the self-perceived load indicators.

The scaling control subsystem, prior to generation of the total load indicator, can modify each self-perceived load indicator according to a decay factor based on an age of the self-perceived load indicator.

The scaling control subsystem, in order to compare the total load indicator to a threshold to select an adjustment action, can: select an increment adjustment action when the total load indicator meets an upper threshold; select a decrement adjustment action when the total load indicator does not meet a lower threshold; and select a no-adjustment action when the total load indicator meets the lower threshold and does not meet the upper threshold.

The scaling control subsystem can, responsive to instruction of the distributed computing subsystem to adjust the number of instances, obtain and store updated instance identifiers corresponding to an adjusted number of the instances.

The scaling control subsystem can include: (i) a load balancing controller to: allocate the received requests among the instances and receive the self-perceived load indicators; and (ii) an instance management controller to: generate the total load indicator; compare the total load indicator to the threshold; and instruct the distributed computing subsystem to adjust the number of instances.

In the examples, a non-transitory computer-readable medium stores computer readable instructions executable by a processor of a scaling control subsystem to: allocate received requests among an adjustable number of instances of a request handling process executed at a distributed computing subsystem; receive respective self-perceived load indicators from each of the instances of the request handling process; generate, based on the self-perceived load indicators, a total load indicator of the distributed computing subsystem; compare the total load indicator to a threshold to select an adjustment action; and; instruct the distributed computing subsystem to adjust the number of instances of the request handling process, according to the selected adjustment action.

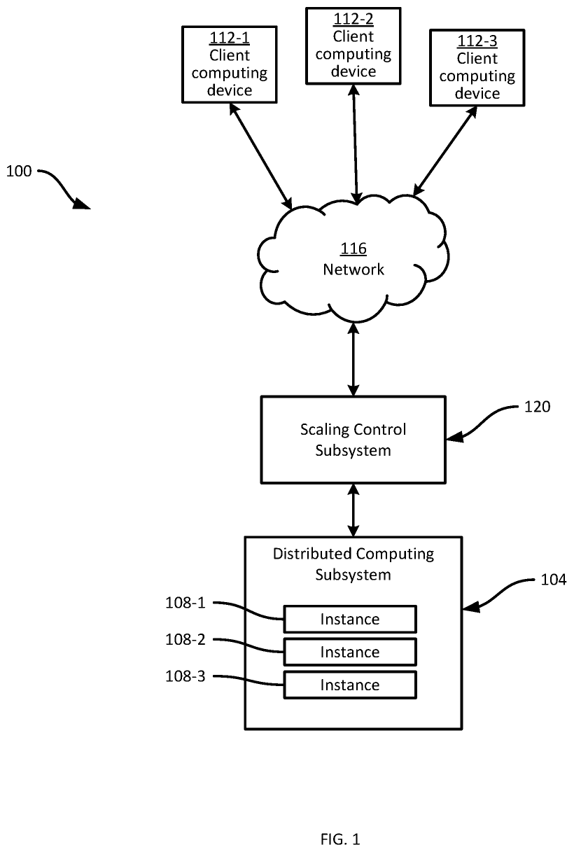

FIG. 1 shows a system 100 in which self-perceived load indicators are used to scale a distributed software application. The system 100 includes a distributed computing subsystem 104 that executes an adjustable number of instances of a software application, also referred to herein as a request handling process. Three examples of instances 108-1, 108-2 and 108-3, which are referred to collectively as the instances 108 and generically as an instance 108, are illustrated in FIG. 1. The number of instances 108 deployed by the distributed computing subsystem 104 can vary.

Each instance 108, as will be discussed below in greater detail, can be executed by dedicated execution hardware such as CPUs, memory devices and the like, executing computer-readable instructions. In other examples, multiple instances 108 can be implemented by a common set of execution hardware, in the form of distinct request handling processes executed by a common CPU and associated memory and/or other suitable components.

The distributed computing subsystem 104 responds to requests from at least one client computing device 112, of which three examples 112-1, 112-2 and 112-3 are shown in FIG. 1. The client computing devices 112 can include any combination of desktop computers, mobile computers, servers, and the like. The client computing devices 112 are referred to herein as client devices because they are considered clients of the distributed computing subsystem 104, although the client computing devices 112 may themselves be servers with downstream client devices (not shown). The client computing devices 112 send requests for processing by the distributed computing subsystem 104 via a network 116, which can include any suitable combination of Local Area Networks (LANs) and Wide Area Networks (WANs), including the Internet.

The nature of the requests sent by the client computing devices 112 for processing by the distributed computing subsystem 104 can vary. For example, the distributed computing subsystem 104 can implement a web server, and the requests can therefore be requests for web pages. The requests, for example, can be HyperText Transfer Protocol (HTTP) requests. In other examples, the distributed computing subsystem 104 can implement an access control server, and the requests can therefore be authentication requests containing login information such as user identifiers and passwords. The distributed computing subsystem 104 processes the requests received from the client computing devices 112. Such processing can include generating responses to the requests. That is, each instance 108 can generate responses to the subset of incoming requests allocated to that particular instance 108.

Each of the instances 108 executed by the distributed computing subsystem 104 also generates a self-perceived load indicator that represents a perception, by the instance 108 itself, of the timeliness with which the instance 108 can respond to requests. Each instance 108 can generate a self-perceived load indicator for each response that the instance 108 generates. In other examples, each instance 108 can generate a self-perceived load indicator at a configurable frequency, such as once every five requests that the instance 108 processes, rather than for every request.

The instances 108 can generate the self-perceived load indicators based on execution timestamps generated during request handling, as will be discussed below in greater detail. The instances 108, using the execution timestamps, can determine an execution time for a given response, representing the length of time taken to generate a response. The instances 108 can then compare the above-mentioned execution times to a stored benchmark execution time. The self-perceived load indicator can be expressed as a ratio of the execution time to the benchmark execution time.

The system 100 also includes a scaling control subsystem 120 connected with the distributed computing subsystem 104. The scaling control subsystem 120 and the distributed computing subsystem 104 can be connected via a LAN, via the network 116, or via a combination thereof. The scaling control subsystem 120 is illustrated in FIG. 1 as a distinct element from the distributed computing system. As illustrated, the scaling control subsystem 120 is deployed on separate execution hardware from the distributed computing subsystem 104. That is, the scaling control subsystem 120 can be deployed on at least one computing device distinct from the computing devices forming the distributed computing subsystem 104. In other examples, the scaling control subsystem 120 can be deployed on the same set of computing devices as the distributed computing subsystem 104, for example as computer-readable instructions distinct from the computer-readable instructions that define request handling process.

The scaling control subsystem 120 allocates incoming requests from the client computing devices 112 among the instances 108 at the distributed computing subsystem 104. To that end, the scaling control subsystem maintains, for example by storing in a list, identifiers of currently active instances 108. The scaling control subsystem 120 also receives the self-perceived load indicators generated by the instances 108, for example in header fields of the responses. That is, a given response can contain the self-perceived load indicator generated using the execution time for that response.

The scaling control subsystem generates, based on the self-perceived load indicators, a total load indicator of the distributed computing subsystem 104. The total load indicator may be, for example, an average of the individual self-perceived load indicators for respective instances 108. Prior to generating the total load indicator, the scaling control subsystem 120 can modify some or all of the self-perceived load indicators according to a decay factor, for example based on the age of the self-perceived load indicators.

The scaling control subsystem 120 then selects adjustment actions by comparing the total load indicator to at least one threshold. For example, the scaling control subsystem 120 can compare the total load indicator to each of an upper threshold and a lower threshold. When the total load indicator is below the lower threshold, the scaling control subsystem 120 can select a decrementing adjustment action, to reduce the number of instances 108 at the distributed computing subsystem 104. When the total load indicator is above the upper threshold, the scaling control subsystem 120 can select an incrementing adjustment action, to increase the number of instances 108 at the distributed computing subsystem 104. When the total load indicator falls between the lower threshold and the upper threshold, the scaling control subsystem 120 can select a no-operation (NOOP), or no-adjustment, action, to retain an existing number of instances 108.

The scaling control subsystem 120 instructs the distributed computing subsystem 104 to adjust the number of deployed instances 108 according to the selected adjustment actions. In other words, the scaling control subsystem 120 both distributes incoming requests amongst the instances 108, and controls the distributed computing subsystem 104 to increase or decrease the number of instances 108 available to process incoming requests. The above-mentioned instance identifiers maintained by the scaling control subsystem 120 are updated in response to the deployment or destruction of an instance 108.

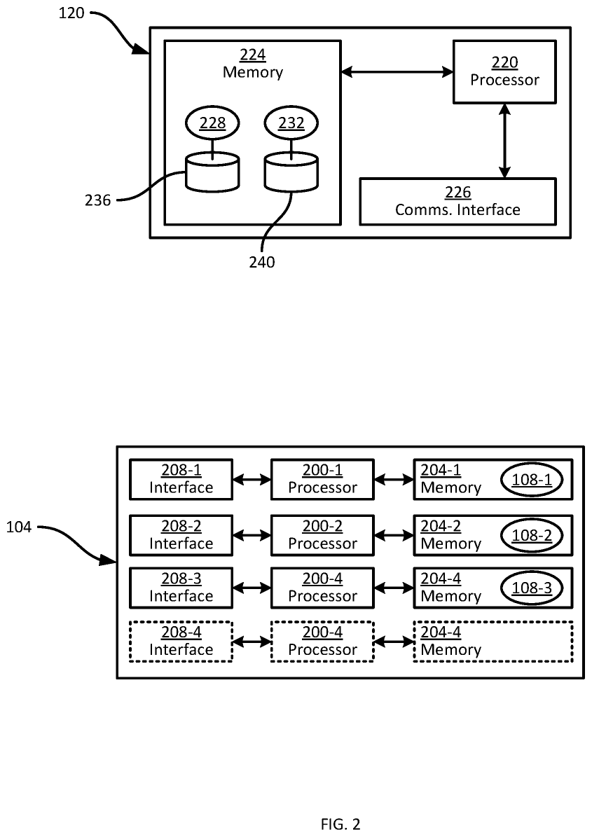

Turning to FIG. 2, certain internal components of the distributed computing subsystem 104 and the scaling control subsystem 120 are illustrated. The distributed computing subsystem 104 includes a plurality of sets of execution hardware. For example, each set of execution hardware can include a processor 200 such as a CPU or the like. Four example sets of execution hardware are shown, and thus four processors 200-1, 200-2, 200-3 and 200-4 are shown. In other examples, the distributed computing subsystem 104 can include a greater number of sets of execution hardware than shown in FIG. 2. In further examples, the distributed computing subsystem 104 can include a smaller number of sets of execution hardware than shown in FIG. 2. Each set of execution hardware can be implemented in a distinct enclosure such as a rack-mounted enclosure. In other examples, the execution hardware can be housed in a common enclosure.

Each processor 200 is interconnected with a respective memory 204-1, 204-2, 204-3 and 204-4. Each memory 204 is implemented as a suitable non-transitory computer-readable medium, such as a combination of non-volatile and volatile memory devices, e.g. Random Access Memory (RAM), read only memory (ROM), Electrically Erasable Programmable Read Only Memory (EEPROM), flash memory, magnetic computer storage, and the like. The processors 200 and the memories 204 are comprised of at least one integrated circuit (IC).

Each processor 200 is also interconnected with a respective communication interface 208-1, 208-2, 208-3 and 208-4, which enables the processor 200 to communicate with other computing devices, such as the scaling control subsystem 120. The communication interfaces 208 therefore include any necessary components for such communication, including for example, network interface controllers (NICs).

Each memory 204 can store computer-readable instructions for execution by the corresponding processor 200. Among such computer-readable instructions are the above-mentioned instances 108. In the example illustrated in FIG. 2, the memories 204-1, 204-2 and 204-3 store computer-readable instructions corresponding, respectively, to the instances 108-1, 108-2 and 108-3. The memory 204-4, as illustrated in FIG. 2, is currently not being used to deploy an instance 108, and the memory 204-4 is therefore shown as not containing an instance 108. When the set of execution hardware including the processor 200-4, the memory 204-4 and the interface 208-4 is instructed to deploy an additional instance 108, a copy of the computer-readable instructions corresponding to the instance 108 may be deployed to the memory 204. In other examples, the memory 204 may store such computer-readable instructions even when at rest. In such examples, the absence of an instance 108 from the memory 204-4 in FIG. 2 indicates that whether or not the relevant computer-readable instructions are stored in the memory 204-4, such instructions are not currently being executed by the processor 200-4.

FIG. 2 also shows that the scaling control subsystem 120 includes a processor 220 such as a CPU or the like, interconnected with a memory 224 such as a combination of non-volatile and volatile memory devices, e.g. Random Access Memory (RAM), read only memory (ROM), Electrically Erasable Programmable Read Only Memory (EEPROM), flash memory, magnetic computer storage, and the like. The processor 220 and the memory 224 are comprised of at least one integrated circuit (IC). The processor 220 is also interconnected with a communication interface 226, which enables the processor 220 to communicate with other computing devices, such as the distributed computing subsystem 104 and the client computing devices 112.

The memory 224 stores computer-readable instructions for execution by the processor 220, including a load balancing application 228 and an instance management application 232. The scaling control subsystem 120, in other words, includes a load balancing controller and an instance management controller. In the illustrated example, the load balancing controller is implemented via execution of the computer-readable instructions of the load balancing application 228 by the processor 220, and the instance management controller is implemented via execution of the computer-readable instructions of the instance management application 232 by the processor 220. In other examples, the load balancing controller and the instance management controller can be implemented by distinct computing devices having distinct processors, with a first processor executing the load balancing application 228 and a second processor executing the instance management application 232. In other examples, the above-mentioned controllers can be implemented by dedicated hardware elements, such as Field-Programmable Gate Arrays (FPGAs), rather than by the execution of distinct sets of computer-readable instructions by a CPU.

The memory 224 also stores, in the illustrated example, a load balancing repository 236 containing identifiers of the instances 108 and self-perceived load indicators received at the scaling control subsystem 120 from the distributed computing subsystem 104. In addition, the memory 224 stores an instance identifier repository 240 containing identifiers corresponding to each active instance 108. The load indicator repository 236 is employed by the load balancing controller, as illustrated by the link between the load balancing application 228 and the load balancing repository 236, to allocate requests among the instances 108 and collect self-perceived load indicators. The instance identifier repository 240 is employed by the instance management controller, as illustrated by the link between the instance management application 232 and the instance identifier repository 240, to update a set of current instance identifiers when adjustments are made to the number of active instances 108. Updates made to the instance identifier repository 240 are propagated to the load balancing repository 236.

The components of the system 100 can implement various functionality, as discussed in greater detail below, to allocate incoming requests and adjust the number of the instances 108 in response to changes in the volume of incoming requests.

In the examples, a method includes: allocating received requests among an adjustable number of instances of a request handling process executed at a distributed computing subsystem; receiving respective self-perceived load indicators from each of the instances of the request handling process; generating, based on the self-perceived load indicators, a total load indicator of the distributed computing subsystem; comparing the total load indicator to a threshold to select an adjustment action; and instructing the distributed computing subsystem to adjust the number of instances of the request handling process, according to the selected adjustment action.

Generating the total load indicator can include generating an average of the self-perceived load indicators.

The method can include, prior to generating the total load indicator, modifying each self-perceived load indicator according to a decay factor based on an age of the self-perceived load indicator.

Comparing the total load indicator to a threshold to select an adjustment action can include: selecting an increment adjustment action when the total load indicator meets an upper threshold; selecting a decrement adjustment action when the total load indicator does not meet a lower threshold; and selecting a no-adjustment action when the total load indicator meets the lower threshold and does not meet the upper threshold.

The method can include, responsive to instructing the distributed computing subsystem to adjust the number of instances, obtaining and storing updated instance identifiers corresponding to an adjusted number of the instances.

Each self-perceived load indicator can be a ratio of an execution time for a corresponding one of the requests to a stored benchmark time.

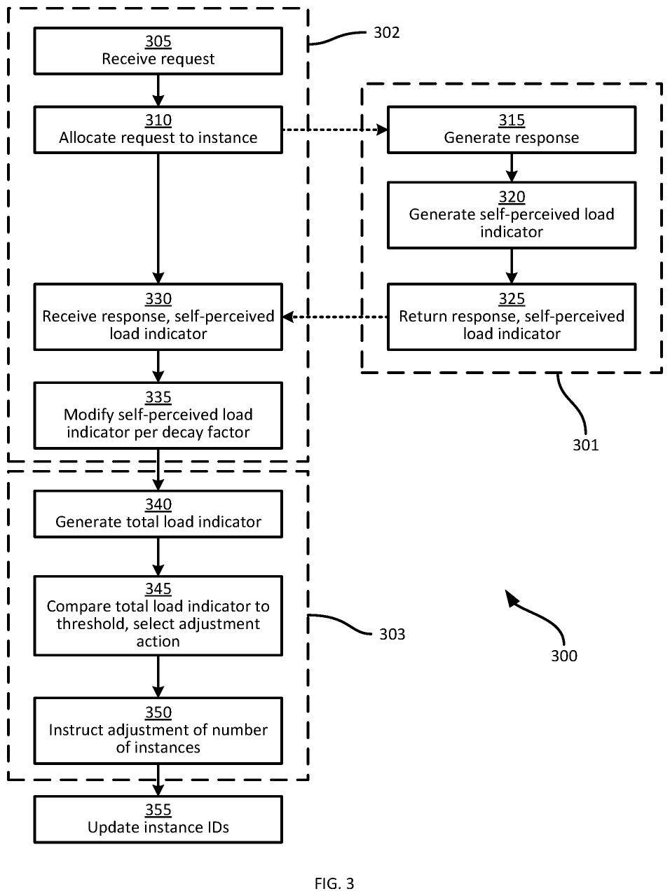

FIG. 3 illustrates a flowchart of a method 300. Example performances of the method 300 are discussed below in conjunction with the performance of the method 300 by the system 100. Certain blocks of the method 300, indicated by the dashed box 301, are performed by the distributed computing subsystem 104. The remaining blocks of the method 300 are performed by the scaling control subsystem 120. More specifically, the blocks within the dashed box 302 are performed by the load balancing controller, e.g. as implemented via execution of the load balancing application 228, and the blocks within the dashed box 303 are performed by the instance management controller, e.g. as implemented via execution of the instance management application 232. Block 355 can involve activities performed at each of the load balancing controller and the instance management controller.

At block 305, the scaling control subsystem 120 receives a request from a client computing device 112, e.g. via the network 116. The request can be received at the processor 220, executing the load balancing application 228, via the communications interface 226 shown in FIG. 2. As noted earlier, a variety of requests are contemplated, including requests for web pages, requests for authentication and/or access to resources, or the like.

At block 310, the scaling control subsystem 120 allocates the request to one of the instances 108. In some examples, the processor 220, via execution of the load balancing application 228, allocates the incoming request to an instance represented in the load balancing repository 236 according to a suitable allocation mechanism. Requests may be allocated according to a round-robin mechanism, for example.

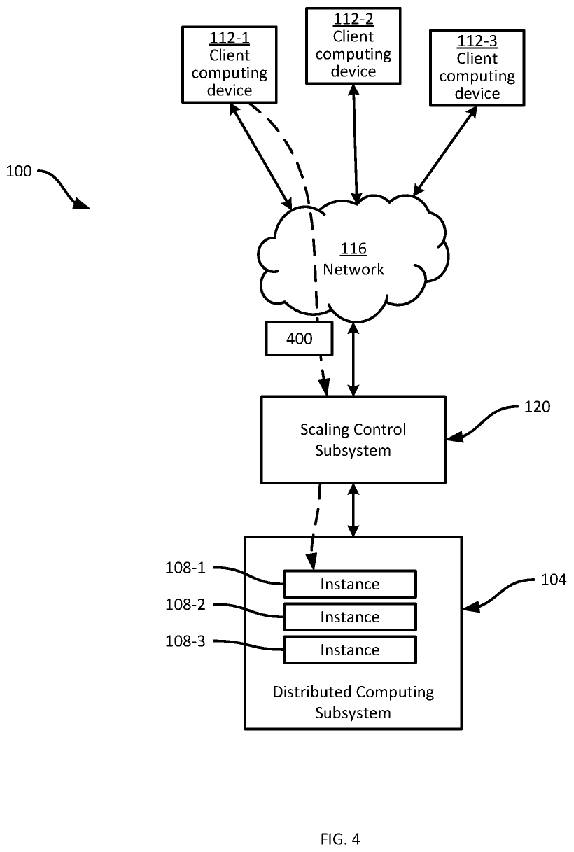

FIG. 4 illustrates an example performance of blocks 305 and 310. A request 400 is received at the scaling control subsystem 120 from the client computing device 112-1, and is allocated to the instance 108-1, e.g. as executed by the processor 200-1 shown in FIG. 2. Allocation of the request 400 may be made by selecting an instance 108 from the load balancing repository 236, an example of which is shown below in Table 1.

TABLE 1
Load Balancing Repository 236

| Instance ID | Load Indicator | Modified Load Indicator |
|---|---|---|
| 108-1 | 0 | 0 |
| 108-2 | 0 | 0 |
| 108-3 | 0 | 0 |

As seen above, the load balancing repository 236 contains identifiers of each active instance 108, as well as corresponding load indicators and modified load indicators. It is assumed that no self-perceived load indicators have yet been received at the scaling control subsystem 120, and the load indicators and modified load indicators are therefore shown as zero in Table 1. The load indicators and modified load indicators may also be blank.

Returning to FIG. 3, following receipt of the request 400, the distributed computing subsystem 104 processes the request 400. For example, at block 315, the instance 108-1 executed by the distributed computing subsystem 104 generates a response to the request 400. The generation of a response can include retrieving a requested web page, validating authentication parameters in the request 400, or the like. At block 320 the instance 108-1 generates a self-perceived load indicator. The self-perceived load indicator can represent, for example a ratio of an execution time for generation of the response at block 315 relative to a benchmark, or expected, execution time. That is, the self-perceived load indicator can represent a length of time taken to generate the response at block 315 compared to an expected response generation time. The self-perceived load indicator therefore indicates, from the perspective of the instance 108 itself, a timeliness with which the instance 108 can accommodate requests.

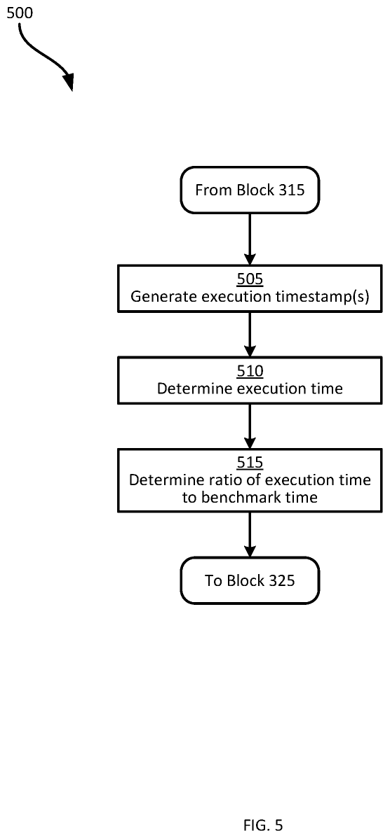

Before continuing with discussion of the method 300, FIG. 5 illustrates an example method 500 of generating a self-perceived load indicator. The method 500 can be performed by each instance 108 for each request received by the instance 108. In other words, each instance 108 of the distributed computing subsystem 104 can generate respective self-perceived load indicators for each of a subset of incoming requests that are allocated to that instance 108.

At block 505, the instance 108 generates at least one execution timestamp for the response generated at block 315. The generation of execution timestamps can be simultaneous with the generation of the response. For example, the computer-readable instructions of the instance 108 can include instructions to generate the response and, embedded within the instructions to generate the response, execution location markers that cause the generation of execution timestamps.

Table 2 contains an example portion of the computer-readable instructions of the instance 108-1, organized into numbered lines of instructions. The example instructions in Table 2 implement a response generation mechanism at block 315. As shown at line 02, the response generation mechanism includes the receipt of a request containing a user identifier in the form of a string, as well as another input in the form of an integer. The response generation mechanism implements three forms of response to incoming requests such as the request 400. The first example behavior, shown at lines 04 to 06, returns an error code “403” if the user identified in the request does not have access rights. The second example behavior, shown at lines 09 to 11, follows successful authentication of the user and returns an error code “400” if the input in the request is invalid. The third example behavior, shown at lines 14 to 16, is performed when the user does have access rights and the input is valid, and returns an “OK” code 200, indicating that the request has succeeded.

TABLE 2
Execution Location Markers

| | |
|---|---|
| 01: | class WebApp { |
| 02: | int handleRequest(String user, Integer input) { |
| 03: | passedHere( ) |
| 04: | if (!hasAccess(user)) { |
| 05: | passedHere( ) |
| 06: | return 403 |
| 07: | } |
| 08: | passedHere( ) |
| 09: | if (!isValid(input)) { |
| 10: | passedHere( ) |
| 11: | return 400 |
| 12: | } |
| 13: | passedHere( ) |
| 14: | businessLogic(input) |
| 15: | passedHere( ) |
| 16: | return 200 |
| 17: | } |
| 18: | } |

The computer-readable instructions shown above also contain execution location markers, shown in Table 2 as the “passedHere” function. Each execution location marker, when processed by the instance 108, may return a line number corresponding to the execution location marker, and a timestamp indicating the time that the execution location marker was processed. In other words, the generation of execution timestamps at block 505 can be caused by the execution location markers shown in Table 2.

For example, processing a request that includes a user identifier with access rights but an invalid input leads to the traversal of three execution location markers, corresponding to lines 03, 08 and 10. The instance 108, in other words, generates three execution timestamps representing the times at which each of the above execution location markers was processed.

In another example, processing a request that includes a user identifier with access rights and a valid input leads to the traversal of four execution location markers, corresponding to lines 03, 08 13 and 15. The instance 108, for such a request, generates four execution timestamps representing the times at which each of the above execution location markers was processed. In some examples, a given instance 108 may receive multiple requests and process the requests in parallel. In such examples, the execution location markers may also include request indicators to distinguish execution location markers generated via processing of a first request from execution location markers generated via contemporaneous processing of a second request.

At block 510, the instance 108 generates an execution time for the response generated at block 315, based on the execution timestamps from block 505. The execution time may be, for example, the time elapsed between the first and last of the above-mentioned execution timestamps.

At block 515, the instance 108 determines a ratio of the execution time to a benchmark time. The benchmark time can be included in the computer-readable instructions of the instance 108, or stored separately, e.g. in the memory 204 that stores the computer-readable instructions of the instance 108. The benchmark time can be previously configured, for example at the time of deployment of the request handling process to the distributed computing subsystem 104. The benchmark time can indicate an expected execution time for responding to the request, as reflected in a service level agreement (SLA) or other performance specification. A plurality of benchmark times may also be stored. For example, a benchmark time can be stored for each of the above-mentioned behaviors, which each correspond to a particular set of execution location markers traversed during response generation. Thus, for the example shown in Table 2, three benchmark times can be stored, examples of which are shown below in Table 3:

TABLE 3
Example Benchmark Times

| Execution Location Markers | Benchmark Time (ms) |
|---|---|
| Lines 03, 05 | 90 |
| Lines 03, 08, 10 | 150 |
| Lines 03, 08, 13, 15 | 200 |

In an example performance of the method 500, the instance 108-1 may traverse the execution location markers 03, 08 and 10, with a time elapsed between the execution location markers 03 and 10 of 120 ms. At block 515, therefore the instance 108-1 determines a ratio of the execution time of 120 ms to the benchmark time of 150 ms. The ratio may be expressed as a percentage, e.g. 80%. The ratio may also be expressed as a fraction between zero and one, e.g. 0.8.

Following generation of the ratio mentioned above, the instance 108 proceeds to block 325. Returning to FIG. 3, at block 325 the instance 108 to which the request was allocated, which is the instance 108-1 in the present example performance of the method 300, returns the response and the self-perceived load indicator to the scaling control subsystem 120. In some examples, the response and the self-perceived load indicator are returned to the load balancing controller. The self-perceived load indicator, which is 0.8 in the present example as discussed above, can be returned within a header field of the response itself, such as an HTTP header field.

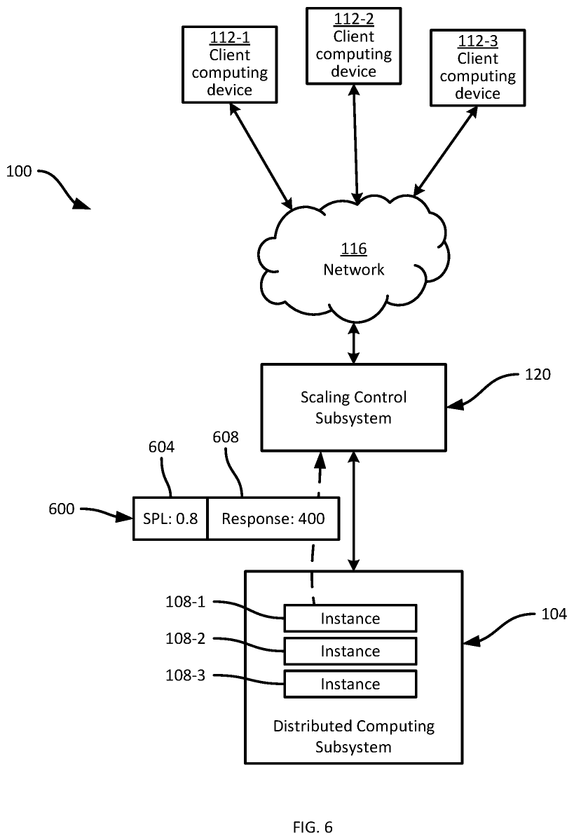

Turning to FIG. 6, an example performance of block 325 is illustrated, in which a response 600, generated by the instance 108-1, is transmitted from the distributed computing subsystem 104 to the scaling control subsystem 120. The response 600 includes a header 604 containing the self-perceived load (SPL) indicator “0.8”, and a body 608 containing the response code “400”. The header 604 can also include other data such as an identifier of the instance 108-1, a timestamp indicating the time the response 600 was generated, or the like.

Returning to FIG. 3, at block 330 the scaling control subsystem 120 receives the response 600 and the self-perceived load indicator contained therein. For example, the response 600 can be received via execution of the load balancing application 228. At block 335, the scaling control subsystem 120 can modify the self-perceived load indicator according to a decay factor. The decay factor can be applied by the load balancing application 228. For example, the decay factor can be determined based on a current time and the time at which the self-perceived load indicator was generated. The time at which the self-perceived load indicator was generated can be indicated by the above-mentioned timestamp in the header 604, and the current time is the time at which block 335 is performed at the scaling control subsystem 120.

The adjustment at block 335 can be implemented by dividing the self-perceived load indicator by the difference between the current time and the time at which the self-perceived load indicator was generated. That is, the decay factor can be the age of the self-perceived load indicator, e.g. in milliseconds. The decay factor can also be based on the age of the self-perceived load indicator, without being equal to the age. For example, the decay factor can be the age of the self-perceived load indicator, normalized to a scale between the values 1 and 5. Various other forms of decay factor may also be employed.

Table 4 illustrates an updated load balancing repository 236 following an example performance of block 335.

TABLE 4
Load Balancing Repository 236

| Instance ID | Load Indicator | Modified Load Indicator |
|---|---|---|
| 108-1 | 0.8 | 0.4 |
| 108-2 | 0 | 0 |
| 108-3 | 0 | 0 |

In Table 4, it is assumed that the age of the self-perceived load indicator generated by the instance 108-1 is 2 ms, and the modified self-perceived load indicator is therefore 0.4.

Following the performance of block 335, the modified load indicators in the load balancing repository 236 can be provided to the instance management controller for further processing. The load balancing controller may update the modified self-perceived load indicators for the entire set of instances 108 and provide the updated modified self-perceived load indicators to the instance management controller each time a new self-perceived load indicator is received from an instance 108. In other examples, the load balancing controller may update the modified self-perceived load indicators for transmission to the instance management controller periodically, e.g. at a configurable frequency.

Before discussing additional blocks of the method 300, additional performances of the request handling process described above are assumed to take place, such that additional self-perceived load indicators are received at the scaling control subsystem 120 from each of the instances 108. Table 5 illustrates a current set of self-perceived load indicators and modifications thereof.

TABLE 5
Load Balancing Repository 236

| Instance ID | Load Indicator | Modified Load Indicator |
|---|---|---|
| 108-1 | 0.95 | 0.95 |
| 108-2 | 1.4 | 1.1 |
| 108-3 | 1.2 | 0.7 |

At block 340, the scaling control subsystem 120, e.g. via execution of the instance management application 232, generates a total load indicator based on the modified load indicators described above. The scaling control subsystem 120 can generate the total load indicator, for example, by generating an average of the individual modified self-perceived load indicators generated at block 335. In the example shown in Table 5, therefore, the total load indicator is the average of the values 0.95, 1.1 and 0.7, or 0.917.

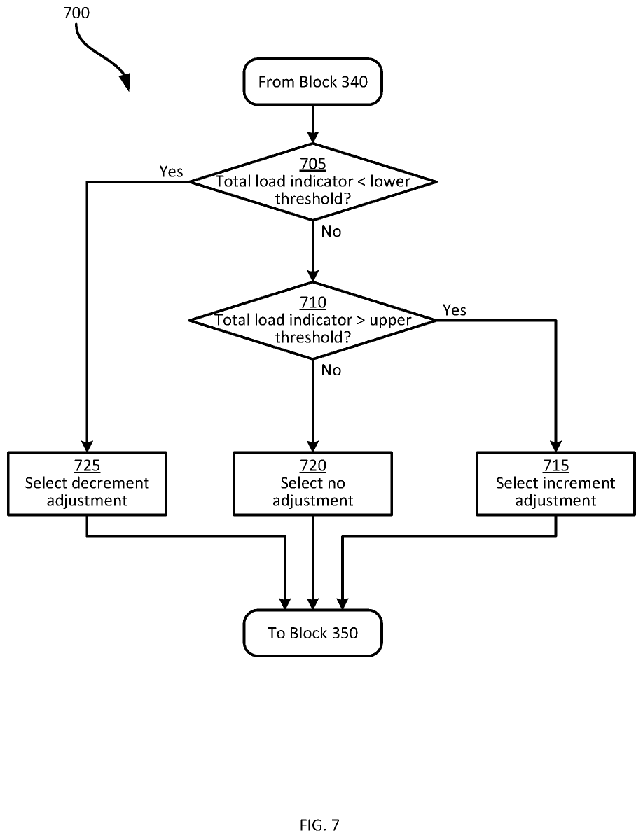

At block 345 the scaling control subsystem 120 compares the total load indicator generated at block 340 with at least one threshold to select an adjustment action. FIG. 7 illustrates an example method 700 of implementing block 345. Referring to FIG. 7, at block 705 the scaling control subsystem 120 (e.g. the instance management controller) determines whether the total load indicator fails to meet a lower threshold. The lower threshold, in the present example, is 0.2, although a wide variety of other lower thresholds may be used in other examples. In the example performance discussed above, the total load indicator of 0.917 exceeds 0.2, and the determination at block 705 is therefore negative.

At block 710, the scaling control subsystem 120 determines whether the total load indicator meets an upper threshold. The upper threshold, in the present example, is 0.8, although a wide variety of other upper thresholds may be used in other examples. In the example performance discussed above, the total load indicator of 0.917 exceeds 0.8, and the determination at block 705 is therefore affirmative. The performance of the method 700 therefore proceeds to block 715, at which the scaling control subsystem 120 selects an incrementing adjustment action. The incrementing adjustment action is an action to increase the number of instances 108-1 by one (that is, to spawn an additional instance 108 of the request handling process).

When the determination at block 710 is negative, the scaling control subsystem 120 instead proceeds to block 720, at which a no adjustment action, also referred to as no-operation or NOOP, is selected. The NOOP action results in no change to the number of instances 108 at the distributed computing subsystem 104.

When the determination at block 705 is negative, the scaling control subsystem 120 proceeds to block 725, at which a decrementing adjustment action is selected. The decrementing adjustment action is an action to reduce the number of instances 108-1 by one (that is, to destroy one instance 108 of the request handling process, releasing execution resources for other tasks).

When an adjustment action has been selected, the scaling control subsystem 120 returns to block 350. Referring again to FIG. 3, at block 350 the scaling control subsystem 120 instructs the distributed computing subsystem 104 to adjust the number of instances 108 of the request handling process, according to the selected adjustment action. In other words, at block 350 the scaling control subsystem 120 (e.g. the instance management controller) instructs the distributed computing subsystem 104 to either create an additional instance 108, destroy an instance 108, or make no changes to the number of instances 108. In the event that the no adjustment action is selected, at block 350 the scaling control subsystem 120 can omit the transmission of an explicit instruction to the distributed computing subsystem 104.

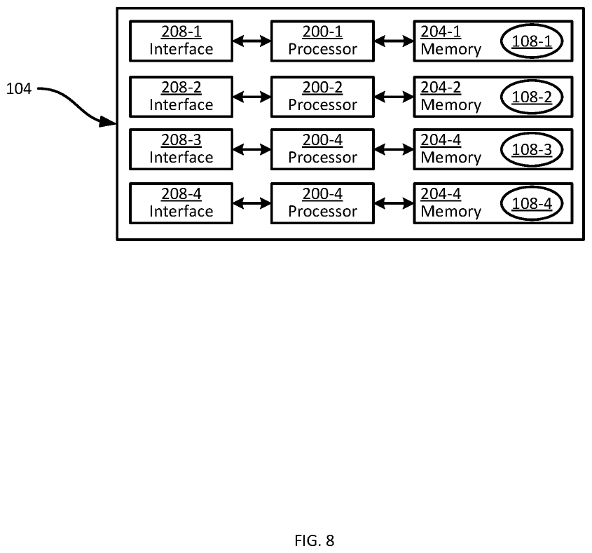

In the example discussed above, the incrementing adjustment action was selected, and therefore at block 350 the scaling control subsystem 120 can instruct the distributed computing subsystem 104 to create an additional instance 108. Turning to FIG. 8, the distributed computing subsystem 104 is shown, in which the processor 200-4, memory 204-4 and communications interface 208-4 have been deployed to implement a fourth instance 108-4 of the request handling process.

At block 355, responsive to any changes to the population of instances 108 deployed at the distributed computing subsystem 104, the scaling control subsystem 120 updates instance identifiers in the instance identifier repository 240 and the load balancing repository 236. For example, Table 6 shows an updated instance identifier repository 240, in which the instance 108-4 is represented along with the instances 108-1 to 108-3. The instance identifier repository 240 can also contain other information such as network addresses corresponding to each of the instances 108.

TABLE 5
Instance identifier repository 240

108-1
108-2
108-3
108-4

Updates to the instance identifier repository 240 can be propagated to the load balancing repository 236, as shown below in Table 6.

TABLE 6
Load Balancing Repository 236

| Instance ID | Load Indicator | Modified Load Indicator |
|---|---|---|
| 108-1 | 0.95 | 0.95 |
| 108-2 | 1.4 | 1.1 |
| 108-3 | 1.2 | 0.7 |
| 108-4 | 0 | 0 |

Further performances of the method 300 can follow, to continue adjusting the number of instances 108 in response to changes in self-perceived load indicators.

Self-perceived load indicators generated internally by the instances 108 may provide a more accurate assessment of computational load at the instances 108 than externally-observable metrics such as CPU utilization. In addition, the use of incrementing or decrementing actions by the instance management controller, selected based on computationally inexpensive threshold comparisons, may allow the use of the above-mentioned assessment of computational load to make automatic scaling decisions while reducing or eliminating the need for computationally costly load estimation mechanisms at the scaling control subsystem 120.

It should be recognized that features and aspects of the various examples provided above can be combined into further examples that also fall within the scope of the present disclosure. In addition, the figures are not to scale and may have size and shape exaggerated for illustrative purposes.

1. A system comprising:
a distributed computing subsystem to execute an adjustable number of instances of a request handling process; and
a scaling control subsystem connected with the distributed computing subsystem to:
allocate received requests among the instances of the request handling process;
receive respective self-perceived load indicators from each of the instances of the request handling process;
generate, based on the self-perceived load indicators, a total load indicator of the distributed computing subsystem;
compare the total load indicator to a threshold to select an adjustment action; and
instruct the distributed computing subsystem to adjust the number of instances of the request handling process, according to the selected adjustment action.

2. The system of claim 1, wherein the distributed computing subsystem executes each instance of the request handling process to:
generate responses to a subset of the requests allocated to the instance;
for each response, generate at least one execution timestamp; and
generate the self-perceived load indicator based on the at least one execution timestamp.

3. The system of claim 2, wherein execution of each instance of the request handling process causes the distributed computing subsystem to:
determine an execution time based on the at least one execution timestamp;
determine a ratio of the execution time to a stored benchmark time; and
return the ratio as the self-perceived load indicator.

4. The system of claim 1, wherein the scaling control subsystem, in order to generate the total load indicator, is to: generate an average of the self-perceived load indicators.

5. The system of claim 4, wherein the scaling control subsystem, prior to generation of the total load indicator, is to: modify each self-perceived load indicator according to a decay factor based on an age of the self-perceived load indicator.

6. The system of claim 1, wherein the scaling control subsystem, in order to compare the total load indicator to a threshold to select an adjustment action, is to:
select an increment adjustment action when the total load indicator meets an upper threshold;
select a decrement adjustment action when the total load indicator does not meet a lower threshold; and
select a no-adjustment action when the total load indicator meets the lower threshold and does not meet the upper threshold.

7. The system of claim 1, wherein the scaling control subsystem is to:
responsive to instruction of the distributed computing subsystem to adjust the number of instances, obtain and store updated instance identifiers corresponding to an adjusted number of the instances.

8. The system of claim 1, wherein the scaling control subsystem includes:
(i) a load balancing controller to:
allocate the received requests among the instances; and
receive the self-perceived load indicators; and
(ii) an instance management controller to:
generate the total load indicator;
compare the total load indicator to the threshold; and
instruct the distributed computing subsystem to adjust the number of instances.

9. A method comprising:
allocating received requests among an adjustable number of instances of a request handling process executed at a distributed computing subsystem;
receiving respective self-perceived load indicators from each of the instances of the request handling process;
generating, based on the self-perceived load indicators, a total load indicator of the distributed computing subsystem;
comparing the total load indicator to a threshold to select an adjustment action; and
instructing the distributed computing subsystem to adjust the number of instances of the request handling process, according to the selected adjustment action.

10. The method of claim 9, wherein generating the total load indicator comprises generating an average of the self-perceived load indicators.

11. The method of claim 9, further comprising: prior to generating the total load indicator, modifying each self-perceived load indicator according to a decay factor based on an age of the self-perceived load indicator.

12. The method of claim 9, wherein comparing the total load indicator to a threshold to select an adjustment action comprises:
selecting an increment adjustment action when the total load indicator meets an upper threshold;
selecting a decrement adjustment action when the total load indicator does not meet a lower threshold; and
selecting a no-adjustment action when the total load indicator meets the lower threshold and does not meet the upper threshold.

13. The method of claim 9, further comprising: responsive to instructing the distributed computing subsystem to adjust the number of instances, obtaining and storing updated instance identifiers corresponding to an adjusted number of the instances.

14. The method of claim 9, wherein each self-perceived load indicator is a ratio of an execution time for a corresponding one of the requests to a stored benchmark time.

15. A non-transitory computer-readable medium storing computer readable instructions executable by a processor of a scaling control subsystem to:
allocate received requests among an adjustable number of instances of a request handling process executed at a distributed computing subsystem;
receive respective self-perceived load indicators from each of the instances of the request handling process;
generate, based on the self-perceived load indicators, a total load indicator of the distributed computing subsystem;
compare the total load indicator to a threshold to select an adjustment action; and;
instruct the distributed computing subsystem to adjust the number of instances of the request handling process, according to the selected adjustment action.
